(19) United States
(12) Patent Application Publication
(10) Pub. No.: US 2024/0351197 A1
(43) Pub. Date: Oct. 24, 2024

(54) ROBOT TEACHING METHOD AND APPARATUS FOR HIGH-LEVEL WORK

(71) Applicant: Electronics and Telecommunications Research Institute, Daejeon (KR)

(72) Inventors: Jeyoun DONG, Daegu (KR); Dongyeop KANG, Daegu (KR); Seung Woo NAM, Daejeon (KR)

(73) Assignee: Electronics and Telecommunications Research Institute, Daejeon (KR)

(21) Appl. No.: 18/516,324

(22) Filed: Nov. 21, 2023

(30) Foreign Application Priority Data
Apr. 19, 2023 (KR) 10-2023-0051315

(51) Int. Cl. B25J 9/16

(52) U.S. Cl. CPC B25J 9/163

(57) ABSTRACT

A robot teaching method and apparatus for high-level work are provided. The robot teaching method includes displaying templates corresponding to a plurality of tasks to be performed by a robot on a display, when any one template of the displayed templates is selected, providing unit tasks included in the selected template, receiving user teaching information for each of the provided unit tasks, and deriving a final teaching result of the robot so that the robot performs a task corresponding to the selected template, by correcting the received user teaching information according to a preset standard.

### CROSS-REFERENCE TO RELATED APPLICATION

This application claims the benefit of Korean Patent Application No. 10-2023-0051315 filed on Apr. 19, 2023, in the Korean Intellectual Property Office, the entire disclosure of which is incorporated herein by reference for all purposes.

### BACKGROUND

### 1. Field of the Invention

One or more embodiments relate to a robot teaching method for high-level work, and more particularly, to a method and an apparatus for performing teaching using an external device such as a handheld device (e.g., a vive or an oculus touch) or an attachable 6-axis mouse for each unit task for high-level work and obtaining a teaching result of high accuracy by correcting the performed teaching.

### 2. Description of the Related Art

In order to utilize a robot, an intention of a user for work needs to be implemented in a form that the robot can understand, which is referred to as teaching. Teaching refers to a technique in which a human transmits a command to a robot to teach the robot to perform a new task or to make the robot perform a possible task.

Such teaching requires a user to directly write a teaching program or input a teaching point using devices (e.x., a tablet, a teaching pendant, or the like), but in order to work on an actual process, only engineers with expertise can do all the work.

In particular, for high-level works (e.g., peg work (peg-in-hole and peg-out-hole work), pivot work, sanding work for flat and curved surfaces, etc.) that require precise teaching of speed, acceleration, and a contact force at which a robot moves, the standardization of the process is difficult and the difficulty level of the work is high. Therefore, for such high-level works, teaching a robot is difficult with current teaching technology.

Accordingly, research and development (R&D) and commercialization technology for a general-purpose teaching apparatus that teaches a robot to easily perform high-level work and for a method of using the general-purpose teaching apparatus are necessary to be secured.

### SUMMARY

One or more embodiments are to provide a method and an apparatus to simply and easily obtain a teaching result even for novices by performing teaching for each unit task for high-level work using an external device that may be easily controlled by users.

In addition, one or more embodiments are to provide a method and an apparatus to obtain a teaching result of high accuracy by correcting user teaching information obtained through teaching according to a preset standard.

However, technical goals are not limited to the foregoing goals, and there may be other technical goals.

According to an aspect, there is provided a robot teaching method including displaying templates corresponding to a plurality of tasks to be performed by a robot on a display, when any one template of the displayed templates is selected, providing unit tasks included in the selected template, receiving user teaching information for each of the provided unit tasks, and deriving a final teaching result of the robot so that the robot performs a task corresponding to the selected template by correcting the received user teaching information according to a preset standard.

The providing of the unit tasks may include arranging the unit tasks included in the selected template according to an operation order of the robot and displaying the unit tasks together with descriptive information corresponding to each of the unit tasks.

The receiving of the user teaching information may include receiving the user teaching information through a handheld terminal that allows a user to intuitively control movement of the robot.

The received user teaching information may include at least one information of speed, acceleration, a contact force, or a trajectory at which the robot moves.

The robot teaching method may further include executing the derived final teaching result of the robot, wherein the executing of the derived final teaching result may include executing the final teaching result of the robot through a virtual simulation or a real robot and displaying an execution result on the display.

The robot teaching method may further include providing a user interface configured to modify the unit tasks included in the selected template, and the receiving of the user teaching information may include receiving the user teaching information for each of the unit tasks modified through the user interface.

According to another aspect, there is provided a robot teaching method including displaying unit tasks operable by a robot on a display together with descriptive information corresponding to each of the unit tasks, generating a task to be performed using the robot by combining unit tasks selected by a user among the displayed unit tasks, receiving user teaching information for each of the unit tasks included in the generated task, and deriving a final teaching result of the robot so that the robot performs the generated task by correcting the received user teaching information according to a preset standard.

The generating of the task may include arranging the unit tasks selected by the user according to a selection order and generating the task to be performed using the robot.

The generating of the task may include identifying whether an omitted unit task is present by analyzing the unit tasks selected by the user, and when the omitted unit task is identified to be present, providing information about an order and a type of the omitted unit task.

The receiving of the user teaching information may include receiving the user teaching information through a handheld terminal that allows a user to intuitively control movement of the robot.

The received user teaching information may include at least one information of speed, acceleration, a contact force, or a trajectory at which the robot moves.

The robot teaching method may further include executing the derived final teaching result of the robot, wherein the executing of the derived final teaching result may include executing the final teaching result of the robot through a virtual simulation or a real robot and displaying an execution result on the display.

According to another aspect, there is provided a robot teaching apparatus including at least one processor and a memory configured to load or store a program executed by the processor, wherein the program may include instructions that cause the processor to display templates corresponding to a plurality of tasks to be performed by a robot on a display, when any one template of the displayed templates is selected, provide unit tasks included in the selected template, receive user teaching information for each of the provided unit tasks, and derive a final teaching result of the robot so that the robot performs a task corresponding to the selected template by correcting the received user teaching information according to a preset standard.

The processor may be configured to arrange the unit tasks included in the selected template according to an operation order of the robot and display the unit tasks together with descriptive information corresponding to each of the unit tasks.

The processor may be configured to receive the user teaching information through a handheld terminal that allows a user to intuitively control movement of the robot.

The received user teaching information may include at least one information of speed, acceleration, a contact force, or a trajectory at which the robot moves.

The processor may be configured to execute the final teaching result of the robot through a virtual simulation or a real robot and display an execution result on the display.

The processor may be configured to provide a user interface configured to modify the unit tasks included in the selected template and receive the user teaching information for each of the unit tasks modified through the user interface.

Additional aspects of embodiments will be set forth in part in the description which follows and, in part, will be apparent from the description, or may be learned by practice of the disclosure.

According to an embodiment, even novices may simply and easily obtain a teaching result by performing teaching for each unit task for high-level work using an external device that may be easily controlled by the users.

In addition, according to an embodiment, a teaching result of high accuracy may be obtained by correcting user teaching information obtained through teaching according to a preset standard.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a configuration of a robot teaching apparatus according to an embodiment;

FIG. 2 is a flowchart illustrating a first robot teaching method performed by a robot teaching apparatus according to an embodiment;

FIG. 3 is a diagram illustrating a robot teaching method using a template according to an embodiment;

FIG. 4 is a diagram illustrating a method of receiving user teaching information, according to an embodiment;

FIG. 5 is a diagram illustrating a method of correcting user teaching information, according to an embodiment;

FIG. 6 is a diagram illustrating a method of confirming corrected user teaching information, according to an embodiment;

FIG. 7 is a diagram illustrating a method of executing the final teaching result, according to an embodiment;

FIG. 8 is a flowchart illustrating a second robot teaching method performed by a robot teaching apparatus according to an embodiment; and

FIG. 9 is a diagram illustrating a robot teaching method using a user-defined task according to an embodiment.

### DETAILED DESCRIPTION

The following detailed structural or functional description is provided as an embodiment only and various alterations and modifications may be made to embodiments. Here, embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms used herein including technical or scientific terms have the same meaning as commonly understood by one of ordinary skill in the art to which embodiments belong. Terms, such as those defined in commonly used dictionaries, should be construed to have meanings matching with contextual meanings in the relevant art and the present disclosure, and are not to be construed as an ideal or excessively formal meaning unless otherwise defined herein.

Hereinafter, embodiments will be described in detail with reference to the accompanying drawings. When describing the embodiments with reference to the accompanying drawings, regardless of drawing numerals, like reference numerals refer to like elements and a repeated description related thereto will be omitted.

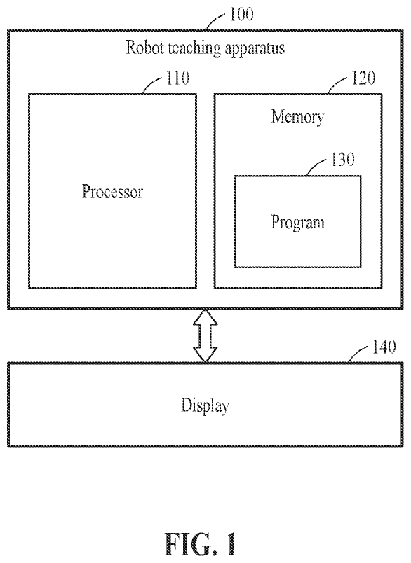

FIG. 1 is a diagram illustrating a configuration of a robot teaching apparatus according to an embodiment.

Referring to FIG. 1, a robot teaching apparatus 100 may include at least one processor 110 and a memory 120 configured to load or store a program 130 executed by the at least one processor 110. The components included in the robot teaching apparatus 100 of FIG. 1 are just an example, and one of ordinary skill in the art may understand that general-purpose components other than the components shown in FIG. 1 may be further included.

The processor 110 may control the overall operation of each component of the robot teaching apparatus 100. The processor 110 may include at least one of a central processing unit (CPU), a microprocessor unit (MPU), a microcontroller unit (MCU), a graphics processing unit (GPU), a neural processing unit (NPU), a digital signal processor (DSP), or any other well-known types of processors in a relevant field of technology. In addition, the processor 110 may perform an operation of at least one application or program to perform the methods/operations described herein according to various embodiments. The robot teaching apparatus 100 may include one or more processors.

The memory 120 may store one of or two or more combinations of various pieces of data, commands, and pieces of information that are used by the components (e.g., the processor 110) included in the robot teaching apparatus 100. The memory 120 may include a volatile memory and/or a non-volatile memory.

The program 130 may include one or more actions through which the methods/operations described herein according to various embodiments are implemented and may be stored in the memory 120 as software. Here, an operation may correspond to a command that is implemented in the program 130. For example, the program 130 may include instructions that cause the processor 110 to display templates corresponding to a plurality of tasks to be performed by a robot on a display, when any one template of the displayed templates is selected, provide unit tasks included in the selected template, receive user teaching information for each of the provided unit tasks, and execute a teaching result of the robot so that the robot performs a task corresponding to the selected template using the received user teaching information.

When the program 130 is loaded in the memory 120, the processor 110 may execute a plurality of operations to implement the program 130 and may perform the methods/operations described herein according to various embodiments.

An execution screen of the program 130 may be displayed on a display 140. In FIG. 1, although the display 140 is illustrated as being a separate device connected to the robot teaching apparatus 100, the display 140 may be included in the components of the robot teaching apparatus 100 when the robot teaching apparatus 100 is a smartphone, a tablet, or other terminals that are portable by a user. The screen displayed on the display 140 may be a state before information is input to the program 130 or may be an execution result of the program 130.

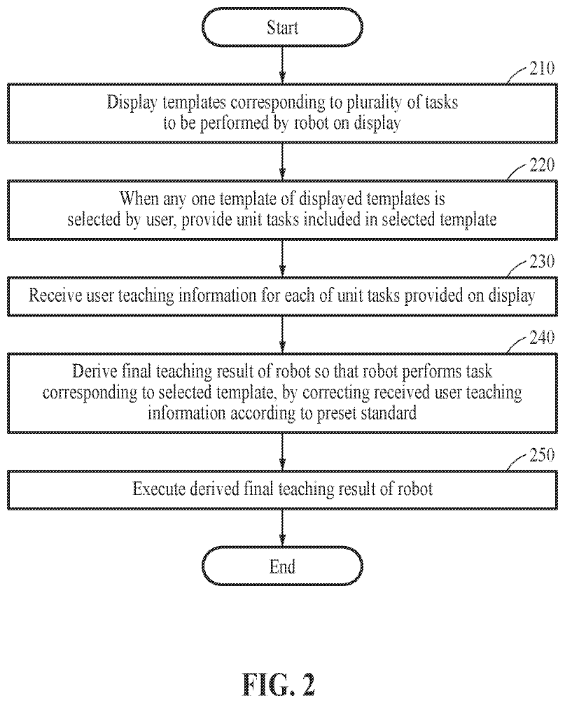

FIG. 2 is a flowchart illustrating a first robot teaching method performed by a robot teaching apparatus according to an embodiment.

The first robot teaching method shown in FIG. 2 is performed by the processor 110 of the robot teaching apparatus 100. The robot teaching apparatus 100 may provide an application that may provide a step-by-step process and a simulation for teaching a robot, particularly teaching for high-level tasks. In the present disclosure, the corresponding application is referred to as a wizard, but this is only one example and embodiments are not limited to the above example.

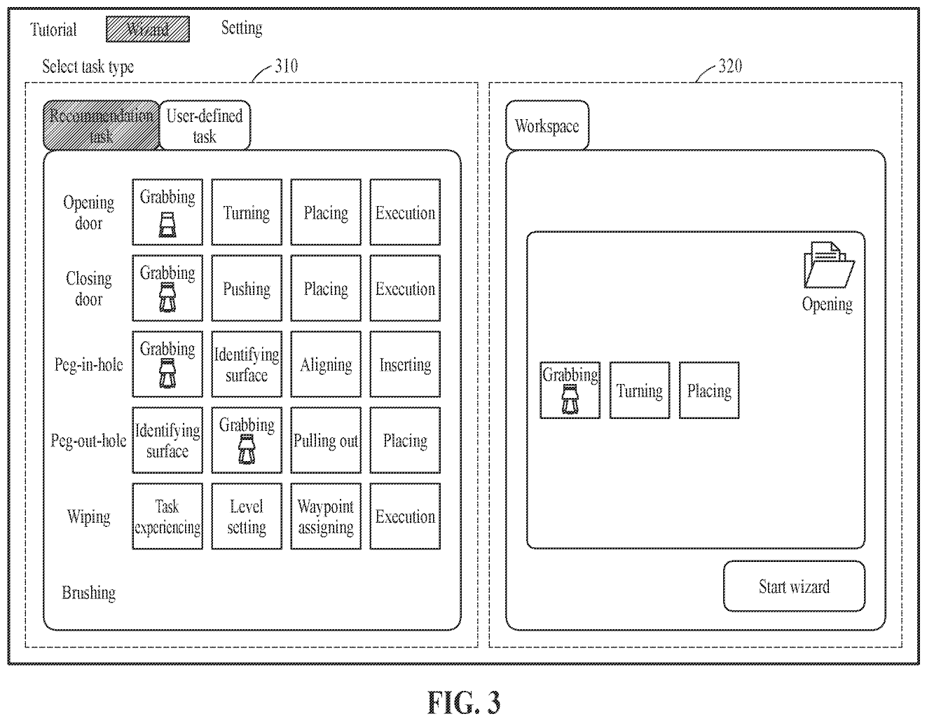

First, in operation 210, the processor 110 may display templates corresponding to a plurality of tasks to be performed by a robot on the display 140. For example, FIG. 3 shows an example of recommendation tasks including templates according to an embodiment. Referring to FIG. 3, the recommendation tasks that may be performed by the robot may include door opening, door closing, a peg-in-hole task, a peg-out-hole task, wiping, and brushing. Here, the templates corresponding to the respective recommendation tasks may include a combination of unit tasks for the robot to perform a corresponding recommendation task.

The processor 110 may display such templates corresponding to the recommendation tasks on a first area 310 of the display 140. Here, the example of the recommendation tasks displayed on the first area 310 is only one example and is not limited to the above example.

In operation 220, when any one template of the templates displayed on the display 140 is selected by a user, the processor 110 may provide unit tasks included in the selected template. Here, the unit tasks included in the selected template may be arranged in order according to an operation order of the robot for performing a recommendation task corresponding to the template.

For example, referring to FIG. 3, when a template corresponding to a peg-in-hole task is selected from among the templates, the processor 110 may arrange unit tasks included in the template corresponding to the peg-in-hole task according to an order of grabbing, identifying a surface, aligning, and inserting, which are an operation order of the robot, and may display the arranged unit tasks on a second area 320 of the display 140.

In operation 230, the processor 110 may receive user teaching information for each of the unit tasks provided on the display 140. Here, the processor 110 may display descriptive information on each of the unit tasks on the display 140 in order to effectively receive the user teaching information for the unit tasks.

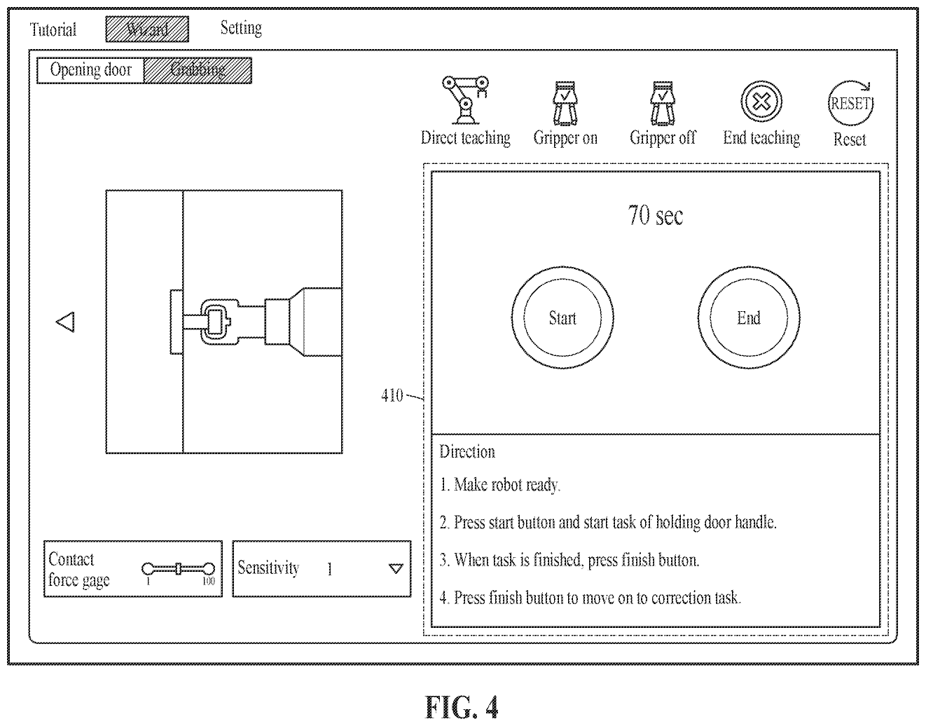

For example, FIG. 4 shows an example of receiving user teaching information according to an embodiment. When the processor 110 is to receive user teaching information for a unit task corresponding to grabbing among the plurality of unit tasks, the processor 110 may display descriptive information to be provided for the user to teach the unit task corresponding to the grabbing on a third area 410 of the display 140.

Then, the user may perform teaching on the unit task corresponding to the grabbing based on the descriptive information displayed on the third area 410, and the processor 110 may receive user teaching information formed as a result of the user performing such teaching.

Here, the user teaching information may also be received through a handheld terminal (e.g., a vibe controller, a joystick, etc.) that may intuitively control the movement of the robot, in addition to a conventional smart device such as a tablet. That is, in the present disclosure, a user may more intuitively perform teaching on the unit tasks through a handheld terminal, so that even a novice user may perform teaching more easily and simply.

In operation 240, the processor 110 may derive the final teaching result of the robot so that the robot performs a task corresponding to the selected template by correcting the received user teaching information according to a preset standard. Here, the received user teaching information may include at least one information of speed, acceleration, a contact force, or a trajectory at which the robot moves.

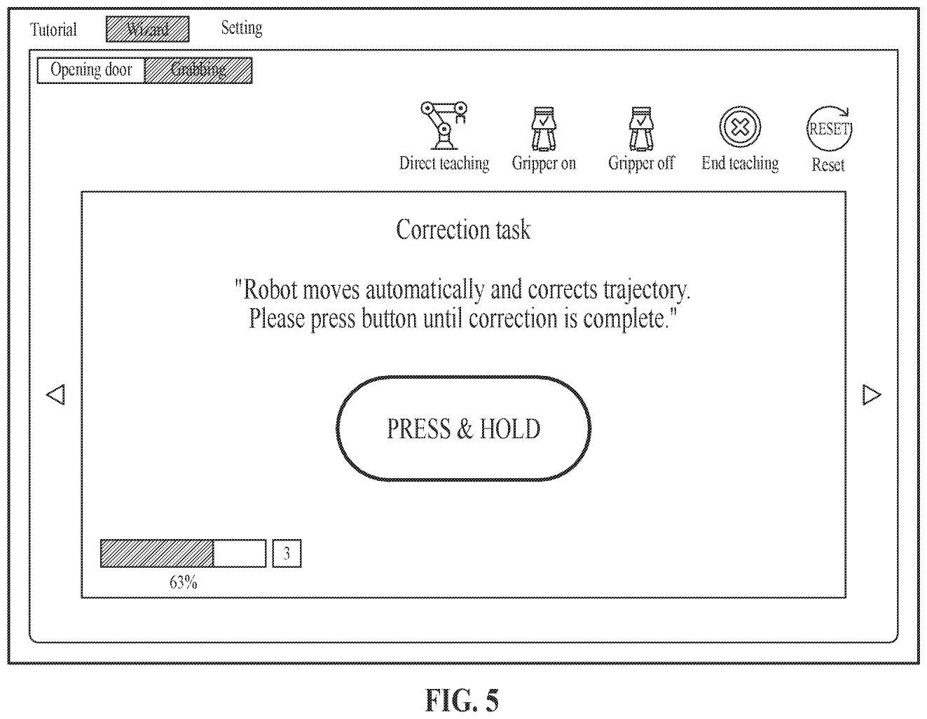

A teaching of a user for a specific unit task received through the handheld terminal may have difficulty of deriving a best teaching result due to the lack of expertise of a user. For example, a movement trajectory of the robot for a specific unit task received through the handheld terminal may include an unnecessary path due to the lack of expertise of a user. Accordingly, the processor 110 may derive an optimal movement trajectory that does not include an unnecessary path by analyzing the movement trajectory of the robot included in the user teaching information, as shown in FIG. 5.

For example, the processor 110 may identify starting point information, destination information, and waypoint information of the robot for performing a specific unit task through the received user teaching information. The processor 110 may extract a shortest movement path of the robot through the identified information and may correct the movement trajectory of the robot included in the user teaching information based on the extracted shortest movement path.

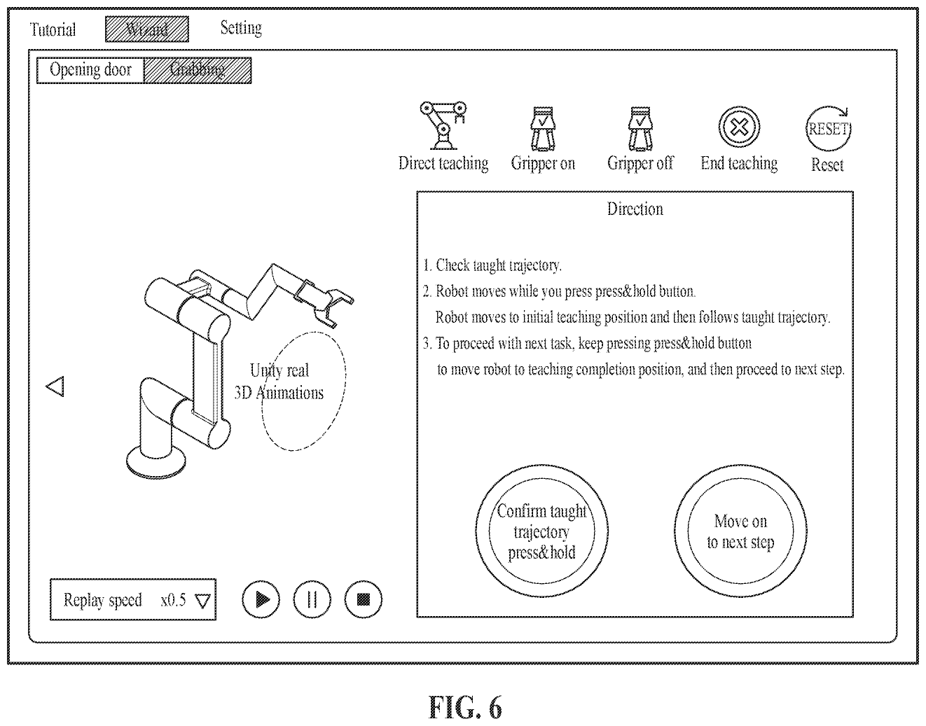

Then, the processor 110 may provide a separate user interface so that the user may confirm the corrected movement trajectory of the robot as shown in FIG. 6. Here, the processor 110 may also simultaneously display the corrected movement trajectory of the robot and the movement trajectory of the robot included in the user teaching information before the correction, so that the user may select an appropriate movement trajectory of the robot.

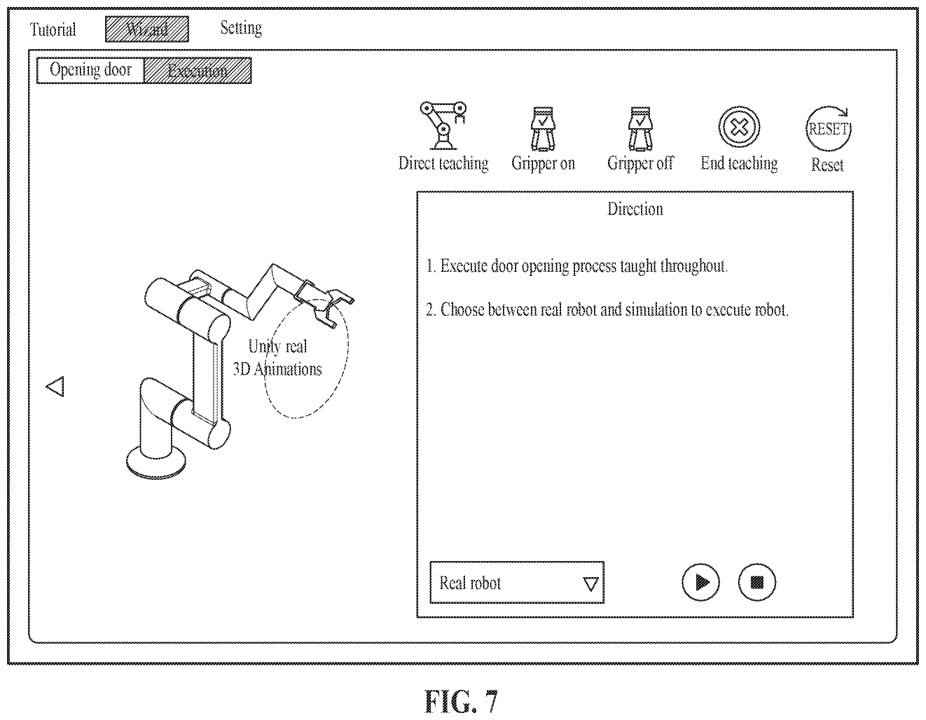

In operation 250, the processor 110 may execute the derived final teaching result of the robot. More specifically, the processor 110 may execute the final teaching result by selecting a virtual simulation or a real robot, as shown in FIG. 7. The processor 110 may perform teaching on high-level work including a plurality of unit tasks by displaying such executed teaching result on the display 140.

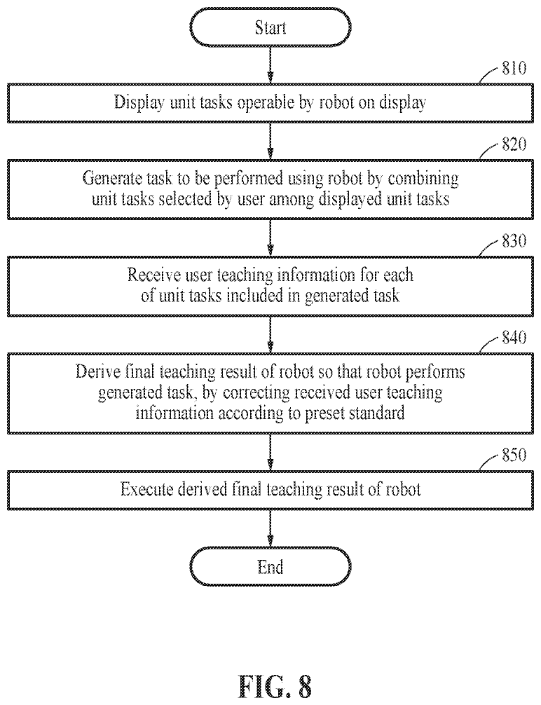

FIG. 8 is a flowchart illustrating a second robot teaching method performed by the robot teaching apparatus 100 according to an embodiment.

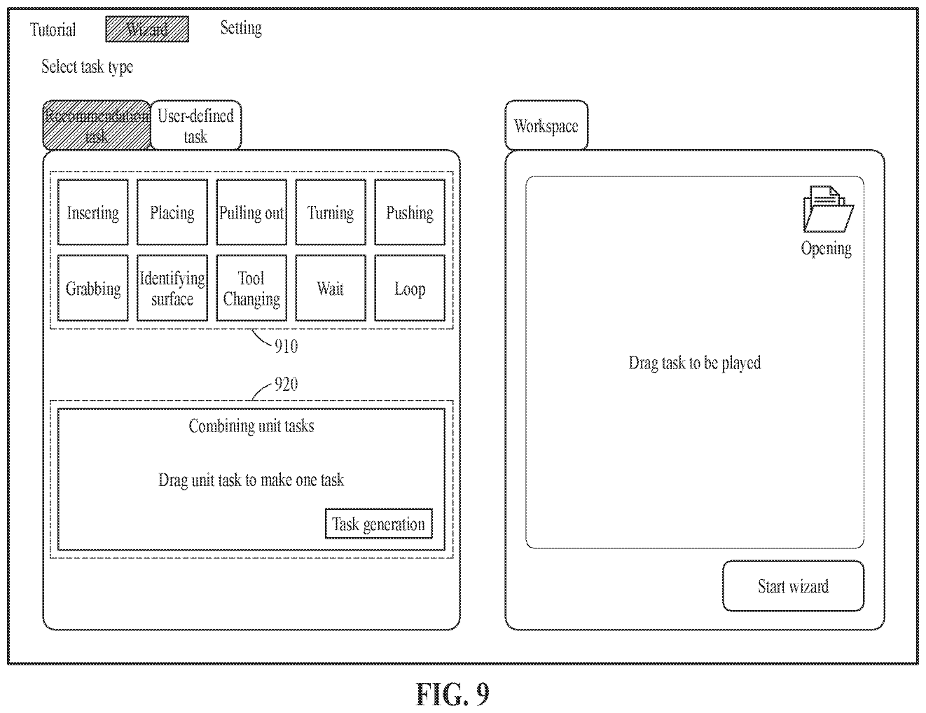

In operation 810, the processor 110 may display unit tasks operable by the robot on the display 140. For example, FIG. 9 shows an example of a user-defined task according to an embodiment. Referring to FIG. 9, unit tasks such as inserting, placing, pulling out, turning, and pushing may be displayed on a fourth area 910 on the display 140.

In operation 820, the processor 110 may generate a task to be performed using the robot by combining unit tasks selected by a user from among the displayed unit tasks. For example, the unit tasks displayed on the fourth area 910 may be moved to a fifth area 920 on the display 140 by a dragging operation, and the processor 110 may combine such unit tasks moved to the fifth area 920 according to an order and may generate a task to be performed by the robot.

However, when a high-level task is generated by combining unit tasks according to a selection of a user, an inaccurate task may be generated depending on the skill level of the user.

Accordingly, the processor 110 may identify whether an omitted unit task is present by analyzing the unit tasks selected by the user. When the omitted unit task is identified to be present, the processor 110 may display information about an order in which the corresponding omitted unit task needs be placed and a type of the omitted unit task on the display 140 to provide the information to the user.

In operation 830, the processor 110 may receive user teaching information for each of the unit tasks included in the generated task. Here, the processor 110 may display descriptive information on each of the unit tasks on the display 140 in order to effectively receive the user teaching information for the unit tasks.

In operation 840, the processor 110 may derive the final teaching result of the robot so that the robot performs the generated task by correcting the received user teaching information according to a preset standard. Here, the received user teaching information may include at least one information of speed, acceleration, a contact force, or a trajectory at which the robot moves.

Finally, in operation 850, the processor 110 may execute the derived final teaching result of the robot using a virtual simulation or a real robot and may perform teaching for the high-level tasks including a plurality of unit tasks by displaying the executed teaching result on the display 140.

The components described in the embodiments may be implemented by hardware components including, for example, at least one DSP, a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. A processing device may be implemented using one or more general-purpose or special-purpose computers, such as, for example, a processor, a controller, an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular; however, one of ordinary skill in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or one or more combinations thereof, to independently or collectively instruct or configure the processing device to operate as desired. Software and/or data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the embodiments may be recorded in non-transitory computer-readable media including program instructions to implement various operations of the embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc-read only memory (CD-ROM) and digital video discs (DVDs); magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

The above-described hardware devices may be configured to act as one or more software modules in order to perform the operations of the above-described embodiments, or vice versa.

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A robot teaching method comprising:
displaying templates corresponding to a plurality of tasks to be performed by a robot on a display;
when any one template of the displayed templates is selected, providing unit tasks included in the selected template;
receiving user teaching information for each of the provided unit tasks; and
deriving a final teaching result of the robot so that the robot performs a task corresponding to the selected template, by correcting the received user teaching information according to a preset standard.

2. The robot teaching method of claim 1, wherein
the providing of the unit tasks comprises arranging the unit tasks included in the selected template according to an operation order of the robot and displaying the unit tasks together with descriptive information corresponding to each of the unit tasks.

3. The robot teaching method of claim 1, wherein
the receiving of the user teaching information comprises receiving the user teaching information through a handheld terminal that allows a user to intuitively control movement of the robot.

4. The robot teaching method of claim 1, wherein
the received user teaching information comprises at least one information of speed, acceleration, a contact force, or a trajectory at which the robot moves.

5. The robot teaching method of claim 1, further comprising:
executing the derived final teaching result of the robot,
wherein the executing of the derived final teaching result comprises executing the final teaching result of the robot through a virtual simulation or a real robot and displaying an execution result on the display.

6. The robot teaching method of claim 1, further comprising:
providing a user interface configured to modify the unit tasks included in the selected template, and
the receiving of the user teaching information comprises receiving the user teaching information for each of the unit tasks modified through the user interface.

7. A robot teaching method comprising:
displaying unit tasks operable by a robot on a display together with descriptive information corresponding to each of the unit tasks;
generating a task to be performed using the robot by combining unit tasks selected by a user among the displayed unit tasks;
receiving user teaching information for each of the unit tasks included in the generated task; and
deriving a final teaching result of the robot so that the robot performs the generated task, by correcting the received user teaching information according to a preset standard.

8. The robot teaching method of claim 7, wherein
the generating of the task comprises arranging the unit tasks selected by the user according to a selection order and generating the task to be performed using the robot.

9. The robot teaching method of claim 7, wherein
the generating of the task comprises:
identifying whether an omitted unit task is present by analyzing the unit tasks selected by the user; and
when the omitted unit task is identified to be present, providing information about an order and a type of the omitted unit task.

10. The robot teaching method of claim 7, wherein
the receiving of the user teaching information comprises receiving the user teaching information through a handheld terminal that allows a user to intuitively control movement of the robot.

11. The robot teaching method of claim 7, wherein
the received user teaching information comprises at least one information of speed, acceleration, a contact force, or a trajectory at which the robot moves.

12. The robot teaching method of claim 7, further comprising:
executing the derived final teaching result of the robot,
wherein the executing of the derived final teaching result comprises executing the final teaching result of the robot through a virtual simulation or a real robot and displaying an execution result on the display.

13. A robot teaching apparatus comprising:
at least one processor; and
a memory configured to load or store a program executed by the processor,
wherein the program comprises instructions that cause the processor to:
display templates corresponding to a plurality of tasks to be performed by a robot on a display;
when any one template of the displayed templates is selected, provide unit tasks included in the selected template;
receive user teaching information for each of the provided unit tasks; and
derive a final teaching result of the robot so that the robot performs a task corresponding to the selected template, by correcting the received user teaching information according to a preset standard.

14. The robot teaching apparatus of claim 13, wherein
the processor is configured to arrange the unit tasks included in the selected template according to an operation order of the robot and display the unit tasks together with descriptive information corresponding to each of the unit tasks.

15. The robot teaching apparatus of claim 13, wherein
the processor is configured to receive the user teaching information through a handheld terminal that allows a user to intuitively control movement of the robot.

16. The robot teaching apparatus of claim 13, wherein
the received user teaching information comprises at least one information of speed, acceleration, a contact force, or a trajectory at which the robot moves.

17. The robot teaching apparatus of claim 13, wherein
the processor is configured to execute the final teaching result of the robot through a virtual simulation or a real robot and display an execution result on the display.

18. The robot teaching apparatus of claim 13, wherein
the processor is configured to provide a user interface configured to modify the unit tasks included in the selected template and receive the user teaching information for each of the unit tasks modified through the user interface.
